(19) United States
(12) Patent Application Publication
(10) Pub. No.: US 2009/0154061 A1
(43) Pub. Date: Jun. 18, 2009

(54) ELECTRIC DOUBLE LAYER CAPACITOR

(75) Inventors: Youichi Nanba, Tokyo (JP); Takashi Mori, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., TOKYO (JP)

(21) Appl. No.: 11/996,145

(22) PCT Filed: Dec. 21, 2006
(86) PCT No.: PCT/JP2006/326170

§ 371 Date: Jan. 18, 2008

Related U.S. Application Data
(60) Provisional application No. 60/752,893, filed on Dec. 23, 2005.

(30) Foreign Application Priority Data
Dec. 21, 2005 (JP) 2005-367376

(51) Int. Cl. H01G 9/038; H01G 9/058

(52) U.S. Cl. 361/502

(57) ABSTRACT

An electric double layer capacitor comprising: activated carbon electrode layers comprising an activated carbon, conductive adhesive layers, a separator, and electrolytic solution comprising non-aqueous solvent and electrolyte between a top vessel and a bottom vessel; in which the top vessel and the bottom vessel are sealed by being caulked with a gasket; in which the activated carbon layers are 0.3 mm or more in a thickness per a layer, not less than 0.55 g/cm³ and not more than 0.8 g/cm³ in an electrode density, and 250% or more in impregnation pickup of electrolytic solution.

This application claims benefit pursuant to 35 U.S.C. §119(e)(1) of Provisional Application No. 60/752,893 filed on Dec. 23, 2005 pursuant to 35 U.S.C. §111(b), the disclosures of which are incorporated herein by reference. This application is based on Japanese Patent Application No. 2005-367376 filed on Dec. 21, 2005, the contents of which are incorporated herein by reference.

### TECHNICAL FIELD

The invention relates to an electric double layer capacitor (alias: an electric double layer condenser). Specifically, the invention relates to a button-type or small coin-type electric double layer capacitor having a high electrostatic capacity and a low internal resistance.

### BACKGROUND ART

An electric double layer capacitor is to supply electric energy from electric double layer formed at an interface between a pair of electrodes as cathode or anode made from an activated carbon and electrolyte. A small coin-type electric double layer capacitor is characterized by high energy density, lightweight, and low influence on the environment. The market of the capacitor sharply increases as memory backup power source for portable apparatus such as mobile phone, digital camera. Especially, in Europe, Asia, Africa, or Middle and Near East, the electric double layer capacitor is popularly employed for memory backup of mobile phone on the digital GSM (Global System for Mobile Communications), in view of the environment. In the market of a small capacitor for memory backup, the electric double layer capacitor having a high capacity per volume and low internal resistance is desired.

In a high performance mobile phone in which a lithium secondary cell is usually used, use of the electric double layer capacitor in stead of the lithium secondary cell is favorable, since the capacitor only comprises carbon and metallic vessel to be easy on the environment.

Conventionally, an electric double layer capacitor have used an electrode having a thickness of 0.005 to 0.25 mm as described in patent document 1. For enlarging an impregnation pickup of electrolytic solution, patent document 2 suggests the use of at least two electrodes having thickness of 150 μm per a layer. The electrode having a thickness of 0.005 to 0.25 mm is easy to be impregnated with the electrolyte, which results in lowering an internal resistance. But it is difficult to increase an electrostatic capacity.

Patent document 3 suggests use of high performance activated carbon prepared by alkali-activation as an activated carbon being an active material for forming an electric double layer in order to increase an electrostatic capacity. Patent document 4 or patent document 5 suggests that a conductive layer comprising conductive particle is formed on a collector, and then an electrode layer is formed on the conductive layer to obtain an electrode.

But, an electric double layer capacitor is further desired to consist both properties of higher capacity and lower resistance.

### [Patent Document 1] JP-A-2004-31986

### [Patent Document 2] JP-A-2004-87824

### [Patent Document 3] JP-B-2548546

### [Patent Document 4] JP-A-2005-191425

### [Patent Document 5] JP-A-2005-136401

### DISCLOSURE OF INVENTION

### Subject to be Solved by the Invention

The object of the invention is to provide an electric double layer capacitor having both of high electrostatic capacity and low internal resistance.

### Means for Solving the Subject

According to the prior art, an electrode layer of an electric double layer capacitor becomes the thicker, permeability and impregnation pickup of electrolytic solution become the lower, contact area of electrode and electrolyte becomes the lower, which surely causes internal resistance of an electric double layer capacitor to increase, lowering output of the capacitor.

But, after the inventors did every research to achieve the goal, it was found out that the activated carbon layers being 0.3 mm or more in a thickness per a layer, not less than 0.55 g/cm³ and not more than 0.8 g/cm³ in an electrode density, and 250% or more in an impregnation pickup of electrolytic solution can allow to obtain an electric double layer capacitor having both of high electrostatic capacity and low internal resistance. The invention is made on the found out knowledge.

The invention specifically comprises the following modes:

(1) An electric double layer capacitor comprising:

activated carbon electrode layers comprising an activated carbon,

conductive adhesive layers,

a separator and

electrolytic solution comprising non-aqueous solvent and electrolyte

between a top vessel and a bottom vessel;

in which the top vessel and the bottom vessel are sealed by being caulked with a gasket;

in which the activated carbon electrode layers are 0.3 mm or more in a thickness per a layer, not less than 0.55 g/cm³ and not more than 0.8 g/cm³ in an electrode density, and 250% or more in impregnation pickup of electrolytic solution.

(2) The electric double layer capacitor according to (1), in which the activated carbon electrode layers are 0.4 mm or more in a thickness per a layer.
(3) The electric double layer capacitor according to (1) or (2), in which the activated carbon electrode layers are not less than 0.65 g/cm³ and not more than 0.8 g/cm³ in an electrode density.
(4) The electric double layer capacitor according to any of (1) to (3), in which the activated carbon electrode layer is 20Ω or less in an impedance at 1 kHz in frequency.
(5) The electric double layer capacitor according to any of (1) to (4), in which the activated carbon electrode layer comprises an activated carbon having a BET specific surface area of 1100 to 2200 m²/g, in which the activated carbon is obtained by activating a graphitizable coke made of coal based pitch or petroleum based pitch as raw material in the presence of alkali metallic compound.
(6) The electric double layer capacitor according to any one of (1) to (5), in which the activated carbon electrode layer comprises an activated carbon which has the highest peak A within the range of 1.0 nm to 1.5 nm, in which the peak A is from 0.012 cm³/g to 0.05 cm³/g and is from 2% to 32% to a total pore volume, in a pore size distribution.
(7) The electric double layer capacitor according to (6), in which the activated carbon further has a peak B within the range of 1.5 to 1.7 nm, a peak C within the range of 1.7 to 2 nm, and a peak D within the range of 2 to 2.5 nm, in a pore size distribution.
(8) The electric double layer capacitor according to any one of (1) to (7), in which the activated carbon electrode layer comprises an activated carbon having average particle size of not less than 2 μm and not more than 15 μm, fluorine containing polymer compound as a binder, and a carbon black and/or a vapor grown carbon fiber as a conductive assistant.
(9) The electric double layer capacitor according to any one of (1) to (8), in which the conductive adhesive layer comprises a carbon black as a conductive particle, and synthetic rubber or acrylic rubber as a binder.
(10) The electric double layer capacitor according to any one of (1) to (9), in which the electrolyte is at least one salt selected from the group consisting of quarternary ammonium salts or quarternary phosphonium salts comprising quarternary onium cation represented by R¹R²R³R⁴N⁺ and R¹R²R³R⁴P⁺ (R¹, R², R³, and R⁴ are respectively alkyl group having 1 to 10 of carbon atom, or allyl group) and anion selected from the group consisting of BF₄⁻, PF₆⁻ and ClO₄⁻; lithium hexafluoro-phosphate (LiPF₆), lithium hexafluoro-borate (LiBF₆), lithium hexafluoro-arsenate (LiAsF₆), and lithium trifluoromethane sulfonate (CF₃SO₃Li).
(11) The electric double layer capacitor according to any one of (1) to (10), in which the non-aqueous solvent is at least one selected from the group consisting of ethylene carbonate, propylene carbonate, di-methyl carbonate, di-ethyl carbonate, methylethyl carbonate, acetonitrile, sulfolane, and methyl sulfolane.
(12) The electric double layer capacitor according to any one of (1) to (11), in which the separator is made from non-woven fabric, cellulosic paper, glass fiber, fluororesin, or polypropylene, and has a thickness of 0.02 to 0.1 mm.
(13) A portable apparatus in which the electric double layer capacitor according to any one of (1) to (12) is employed.

### EFFECT OF THE INVENTION

The electric double layer capacitor in the invention is low in an internal resistance and rechargeable with high current, and high in an electrostatic capacity. The electrolyte permeability is a property that electrolytic solution permeates an electrode. The electrolytic solution permeates for shorter time, the electrolyte permeability is the more excellent. The impregnation pickup of electrolytic solution is the amount of electrolytic solution held in an electrode after the electrolytic solution permeates the electrode. The amount of electrolytic solution can be usually determined by weight of electrolytic solution. The amount of electrolytic solution becomes the more, an electrolyte pickup becomes more excellent.

### BRIEF EXPLANATION OF THE DRAWINGS

FIG. 1: Section of an electric double layer capacitor in the invention.

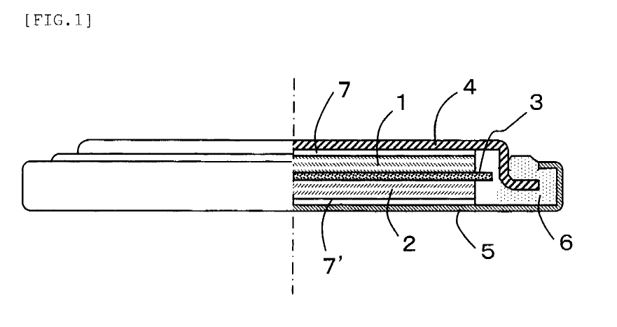

### EXPLANATION OF THE SYMBOL

1, 2: activated carbon electrode layer
3: separator
4: top vessel
5: bottom vessel
6: gasket
7, 7′: conductive adhesive layer

### BEST MODE FOR CARRYING OUT THE INVENTION

An electric double layer capacitor in the invention comprises activated carbon electrode layers comprising an activated carbon, conductive adhesive layers, a separator, and electrolytic solution comprising non-aqueous solvent and electrolyte between a top vessel and a bottom vessel. The top vessel and the bottom vessel are sealed by being caulked with a gasket. The activated carbon electrode layers are 0.3 mm or more, preferably 0.4 mm or more in a thickness per a layer, not less than 0.55 g/cm³ and not more than 0.8 g/cm³ in an electrode density, and 250% or more in impregnation pickup of electrolytic solution.

An impregnation pickup of electrolytic solution is represented by a ratio of post-impregnation mass/ante-impregnation mass. The ante-impregnation mass is determined by weighing a virgin electrode sheet accurately. The electrode sheet is steeped in a set electrolytic solution, and the electrolytic solution is impregnate into the electrode sheet before the impregnated electrode sheet is accurately weighed to determine the post-impregnation mass.

In the invention, activated carbon electrode layers being 0.3 mm or more in a thickness per a layer are employed for an electrode. When the thickness of electrode layer is less than 0.3 mm, electric double layer capacitor does not give the set capacity per a cell since an active material (activated carbon) is insufficient in quantity for an electric double layer capacitor. The preferable maximum thickness of electrode layer, depends on a volume of cell and volume of other member such as separator and so on, is preferably 0.5 mm on 614 coin type cell (6.8 mmΦ×1.4 mmt), is preferably 0.5 mm on 414 coin type cell (4.8 mmΦ×1.4 mmt), and is preferably 0.4 mm on 311 coin type cell (3.8 mmΦ×1.1 mmt). The thickness of electrode layer is so thick that trouble such as short circuit is apt to be made at the time of assembling

The electric double layer capacitor in the invention is not less than 0.55 g/cm³ and not more than 0.8 g/cm³, preferably not less than 0.65 g/cm³ and not more than 0.8 g/cm³, in an electrode density of an activated carbon electrode layer. Electrode density within the range enlarges contact area between an electrode and an electrolytic solution, resulting in being good permeability and impregnation pickup of the electrolytic solution.

The activated carbon electrode layer is preferably 20Ω or less in impedance at 1 kHz in frequency. Impedance becomes the lower, charging and discharging can be conducted with the larger electric current, and chargeable and dischargable capacity becomes the larger.

The activated carbon electrode layer is made from an activated carbon. The preferable activated carbon has the highest peak A within the range of 1 nm to 1.5 nm, in which the peak A is from 0.012 cm³/g to 0.05 cm³/g and is from 2% to 32% to a total pore volume, in a pore size distribution.

Pore size distribution of an activated carbon can be calculated by BJH method from N₂-adsorption isotherm at 77.4 K. Concretely, activated carbon is cooled down to 77.4 K (boiling point of nitrogen), nitrogen gas is introduced, and adsorption quantity of nitrogen gas V [cc/g] is measured by volume method. The measurement values are plotted onto x-axis of ratio (P/P₀) of equilibrium adsorption pressure of nitrogen gas P [mmHg] and saturated vapor pressure of nitrogen gas P₀ [mmHg], and y-axis of adsorption quantity of nitrogen gas V [cc/g] to make N₂-adsorption isotherm. Pore size distribution analysis is carried out by BJH (Barrett-Joyner-Halenda) method from the N₂-adsorption isotherm. BJH method, which is well known in the art, for instance, may be carried out by the method as described in J. Amer. Chem. Soc. 73, 373. (1951).

The activated carbon preferably used in the invention has the highest peak A within the range of 1 to 1.5 nm, preferably 1.2 to 1.4 nm in a pore size distribution. Height of peak A is 0.012 to 0.05 cm³/g, preferably 0.02 to 0.05 cm³/g. When peak A is within the above range of an pore size, it is not easy to increase an internal resistance even though the electrode layer thickens. The preferable activated carbon used in the invention has a peak B within the range of 1.5 to 1.7 nm, a peak C within the range of 1.7 to 2 nm, and a peak D within the range of 2 to 2.5 nm, in a pore size distribution.

The activated carbon preferably used in the invention is 2 to 32%, preferably 20 to 31% to a total pore volume in the peak A within the range of 1 to 1.5 nm in a pore size distribution. Peak A being within the range does not allow to be easy to enlarge internal resistance even though the electrode layer thickens.

The activated carbon preferably used in the invention has a BET specific surface area of preferably 1100 to 2200 m²/g, especially preferably 1800 to 2100 m²/g. BET specific surface area is so large that electrode density of electrode sheet in an electric double layer capacitor is decreased, which allows to be apt to decrease an electric capacity per volume which is asked of a capacitor. BET specific surface area is so small that an electric capacity per mass of activated carbon is apt to be decreased.

A producing method of the activated carbon used in the invention, is not limited, preferably comprises:

process (A) comprising the steps of carbonizing a pitch in the presence of 7000 ppm or more in metallic element concentration of alkaline earth metallic compound to obtain a graphitizable coke having a true density of 1.44 to 1.52 g/cm³, activating the graphitizable coke in the presence of alkali metallic compound, and then washing the activated coke, or

process (B) comprising steps of carbonizing pitch to obtain a graphitizable coke having a true density of 1.44 to 1.52 g/cm³, mixing the graphitizable coke with 7000 ppm or more in metallic element concentration of alkaline earth metallic compound to obtain mixture, activating the mixture in the presence of alkali metallic compound, and then washing the activated mixture.

It is preferable that the pitch used in the producing method of the activated carbon has a low softening point. In the pitch, there are mentioned petroleum based pitch, coal based pitch and so on. In these, coal based pitch, especially organic solvent soluble constituent of coal based pitch is particularly preferably used in the invention. The pitch has less side chain, and higher content of aromatic compound that mingles polycyclic aromatic compounds having various molecular structure. It is considered that an activated carbon made of the pitch has formation of various complicated micro-crystalline structure coming from the polycyclic aromatic compounds, which causes a good gas adsorption property. The pitch used in the invention is preferably not more than 100° C., more preferably 60 to 90° C. in a softening point.

Alkaline earth metallic compound, is not particularly limited, may be simple substance or compound containing at least one alkaline earth metallic element selected from the group consisting of beryllium, magnesium, calcium, strontium, barium and radium. Any of inorganometallic compound and organometallic compound may be used.

Examples as inorganic compounds of alkaline earth metal are oxides, hydroxides, chlorides, bromide, iodide, fluoride, phosphate, carbonate, sulfide, sulfate and nitrate.

Mentioned as organic compounds of alkaline earth metal are organometallic complexes with ligand such as acetylacetone, cyclopentadien.

Favorable alkaline earth metallic compounds used in the invention are oxide, carbonate or sulfide containing at least one alkaline earth metallic element selected from beryllium, magnesium, calcium, strontium, barium and radium, more specifically are magnesium oxide, calcium oxide, calcium carbonate, calcium sulfide, strontium fluoride, or magnesium phosphate. The alkaline earth metallic compound may be used alone or in combination with two or more.

In a process (A) of producing an activated carbon, first of all, a pitch is carbonized in the presence of alkaline earth metallic compound to obtain a graphitizable coke having a true density of 1.44 to 1.52 g/cm³. Specifically, the pitch and the alkaline earth metallic compound are mixed, and the mixture may be heated. The manner for mixing of the pitch and the alkaline earth metallic compound is not particularly limited if they can be uniformly mixed. For instance, at room temperature, powder of alkaline earth metallic compound is added into pitch powder, and is stirred to obtain mixture. Mentioned as the means for stirring are V-shaped Mixer, Henschel mixer, Nowter mixer and the like. Using of the means for mixing may allow to obtain the uniform mixture.

The alkaline earth metallic compound is used 7000 ppm or more in metallic element concentration. In case of less than 7000 ppm, it does not enough work as catalyst for the activation step. Metallic element concentration (ppm) is the value as calculated by the following formula:

[mass of alkaline earth metallic element]/([mass of pitch]+[mass of alkaline earth metallic compound])×10⁶

The manner for carbonizing is not particularly limited, to start with, first carbonization step is carried out within the range of 400 to 700° C., preferably 450 to 550° C. in temperature, and then, second carbonization step is carried out within the range of 500 to 700° C., preferably 540 to 670° C. in temperature. Temperature in the second carbonization step is usually higher than that in the first carbonization step.

The carbonization invites pyrolysis reaction on pitch. The pyrolysis reaction causes to desorb gas and light fraction from the pitch, polycondensing residue thereof to obtain solid finally. The carbonization step almost decides micro-bounding state between carbon atoms. The decided crystalline structure of coke in the step determines foundation of structure of resultant activated carbon.

Temperature of no more than 400° C. in first carbonization step unlikely causes enough pyrolysis reaction and carbonization. Temperature of no less than 700° C. is tend to make a surfeit of graphite like micro-crystalline structure parts, and to be difficult for activation with alkali compound.

The first carbonization step is preferably 3 to 10° C./hr, more preferably 4 to 6° C./hr in a heating rate, and preferably 5 to 20 hours, more preferably 8 to 12 hours in period of holding at maximum temperature.

Temperature of no more than 500° C. in the second carbonization step is not apt to cause working enough the second carbonization step. Temperature of no less than 700° C. in the second carbonization step is tend to make a surfeit of graphite like micro-crystalline structure parts, and to be difficult for activation with alkali compound.

The second carbonization step is preferably 3 to 100° C./hr, more preferably 4 to 60° C./hr in a heating rate, and preferably 0.1 to 8 hours, more preferably 0.5 to 5 hours in period of holding at maximum temperature. In the second carbonization step, high heating rate, short period of holding at maximum temperature, and low cooling rate may allow to provide the activated carbon used in the invention. It is preferable to take 5 to 170 hours to lower the temperature from maximum temperature to room temperature.

The graphitizable coke obtained by the above carbonization step is to have true density of preferably 1.44 to 1.52 g/cm³, more preferably 1.45 to 1.52 g/cm³. The true density falling within the range may allow to provide the activated carbon used in the invention easily. A true density is measured by liquid-phase substitution method (picno meter method).

It is preferable that the graphitizable coke obtained by the above carbonization step is milled into an average particle diameter of 1 to 30 μm before the following activation with alkali metallic compound. The manner for milling is not particularly limited. Mentioned as known milling apparatus are jet mill, vibration mill, Balberizer, and the like. If the graphitizable coke without milling at that is activated, metallic contamination in particle can not be sometimes enough removed from the resultant activated carbon. The remain of metallic contamination likely causes to cut down a life of the adsorbent.

In the process (A) of producing an activated carbon, afterward, the obtained graphitizable coke is activated in the presence of alkali metallic compound. Specifically, the graphitizable coke is mixed with alkali metallic compound, and the mixture is heated.

Alkali metallic compound used in the producing method of an activated carbon in the invention is not particularly limited. Alkali metallic hydroxide such as sodium hydroxide, potassium hydroxide, cesium hydroxide is preferable as alkali metallic compound. Alkali metallic compound is used preferably 1.5 to 5 times, more preferably 1.7 to 3 times as heavy as the coke.

An activating temperature is usually 600 to 800° C., preferably 700 to 760° C. An activation is usually carried out in atmosphere of inert gas. As inert gas are mentioned nitrogen gas, argon gas and the like. Also, water vapor, carbon dioxide and so on, if needs be, may be introduced during activation.

In the activation, for instance, when potassium hydroxide is used, potassium hydroxide is molten and dehydrated at 300 to 400° C. Activation reaction occurs with potassium metal and water vapor at 400° C. or more.

At this point, the reactant changes from liquid state into solid state, gas such as carbon monoxide (CO), carbon dioxide (CO₂), and hydrogen (H₂) simultaneously generates from the reactant by oxidation of carbon. The generation of gas invites sparkle or bumping in reactant, boiling over reactant, which requires volume of vessel enough larger than that of the reactant.

In the producing method of the activated carbon, alkali metal obtained by reduction reaction of alkali metallic compound enters and opens between carbon layers of the graphitizable coke to make many spaces.

In the conventional activation with alkali metal, using of carbon by reaction with coke results in making pore, and space between carbon layers made by alkali metal is small.

In the producing method of the activated carbon, the activation can be carried out in the presence of alkali metal vapor. The alkali metal vapor can be used instead of solid alkali metallic compound or together solid alkali metallic compound, since the intercalation of alkali metal between carbon layers makes pore.

In the producing method of the activated carbon, finally, the activated coke is washed with water, acids or so on.

As the acid used in the acid-washing are mentioned inorganic acids such as sulfuric acid, phosphoric acid, hydrochloric acid, and nitric acid, and organic acid such as formic acid, acetic acid, and citric acid. In the view of washing efficiency and removability, hydrochloric acid or citric acid is preferable. Concentration of acid is preferably 0.01 to 20 normality, more preferably 0.1 to 1 normality.

In a manner for washing, acid may be added to and mixed with the activated coke. Boiling or heating at 50 to 90° C. is preferable for improvement of washing efficiency. Also use of ultrasonic wave washer is effective. Washing time is usually 0.5 to 24 hours, preferably 1 to 5 hours.

Number of washing operation depends on the manner for washing. For example, 1 to 5 boiled-acid-washing operations and then 1 to 5 heated-water-washing operations are preferable for removal of residual chloride. A vessel made from material such as glass lining, tantalum, and TEFLON (registered trade mark) is preferably used in the acid-washing operation.

In the washing step, full automatic mixing and heating filter dryer such as multi function filter (WD Filter provided by NISSEN Co. Ltd.) and FV dryer (provided by OKAWARA MFG. Co. Ltd.) may be used. Pure water used for washing has ionic electric conductivity of no more than 1 μS/cm. A waste fluid from washing step may be reused as a part of washing water by recycling.

In the other process (B) for producing the activated carbon, first of all, a pitch is carbonized to obtain a graphitizable coke having a true density of 1.44 to 1.52 g/cm³. The manner for carbonizing is the same as that described in the above process (A), except that alkaline earth metallic compound is absent in the step of carbonization.

Then, 7000 ppm or more in metallic element concentration of alkaline earth metallic compound is mixed with the graphitizable coke obtained by the above carbonization, and the mixture is activated in the presence of alkali metallic compound. Specifically, the graphitizable coke, alkali metallic compound and alkaline earth metallic compound may be mixed and heated. The manner for the activation is the similar to that described in the above process (A). The metallic element concentration is the value calculated by the following formula:

[mass of alkaline earth metallic element]/([mass of coke]+[mass of alkaline earth metallic compound])×10⁶

Finally, the coke activated by the above step is washed. The manner for washing is the same as that described in the above process (A).

The activated carbon electrode layer preferably comprises an activated carbon having an average particle size of not less than 2 μm and not more than 15 μm, fluorine containing polymer compound as a binder, and carbon black or/and vapor grown carbon fiber (VGCFs) as a conductive assistant.

The vapor grown carbon fiber is compounded with the activated carbon to improve the property more. The manner for compounding the vapor grown carbon fiber with the activated carbon is not particularly limited. It is preferable that the mixture of the vapor grown carbon fiber and the graphitizable coke is activated to obtain the carbon composite powder comprising the vapor grown carbon fiber and the activated carbon. This manner decreases a contact resistance between the particles, increases an electric conductivity and a mechanical strength of electrode, and lowers a dilatation rate of the electrode at the time of applying voltage. Also, the carbon composite powder may be produced by simply mixing the vapor grown carbon fiber with the activated carbon. The carbon composite powder has larger thermal conductivity than the activated carbon alone has.

The vapor grown carbon fiber compounded with the activated carbon may be produced by, for example, spraying benzene and metallic catalyst particle into current of hydrogen gas at approximately 1000° C. A graphitized carbon fiber may be employed, in which the carbon fiber obtained by the spray method or the like is burned at 1000 to 1500° C. and then is further burned at 2500° C. or more to obtain the graphitized carbon fiber.

The vapor grown carbon fiber preferably has pore therein, a specific surface area of 10 to 50 m²/g, an average diameter of fiber of 50 to 500 nm, and an aspect ratio of 5 to 1000. Any vapor grown carbon fiber such as a linear carbon fiber, a branched carbon fiber or mixture thereof may be employed.

The preferable fiber length of the vapor grown carbon fiber is 0.5 to 2 times as long as average diameter of the activated carbon. When vapor grown carbon fiber length is shorter than 0.5 time, crosslinking of carbon fiber between the activated carbon particles is not made, being likely insufficient in an electric conductivity. When carbon fiber length is longer than 2 times, carbon fiber unlikely interposes between activated carbon particles, likely lowering a mechanical strength of polarizable electrode.

A vapor grown carbon fiber treated by activation such as gas activation (water vapor, carbon dioxide and so on), chemical activation (zinc chloride, phosphoric acid, calcium carbonate and so on), alkaline activation (potassium hydroxide, sodium hydroxide, and so on) can be employed, as the vapor grown carbon fiber has a concentric circular orientation structure. In this situation, the carbon fiber having a controlled surface structure which has a micro pore (having a pore diameter of 2 nm or less) volume of 0.01 to 0.4 cm³/g, and BET specific surface area of 10 to 500 m²/g is preferable. The micro pore volume is so large that ion diffusion resistance in the electrode may unfavorably rise.

The amount of the vapor grown carbon fiber is preferably 0.02 to 20% by mass, more preferably 0.1 to 20% by mass, particularly preferably 0.5 to 10% by mass, based on the activated carbon. The vapor grown carbon fiber of less than 0.02% by mass works only a little gain in thermal conductivity of carbon composite powder mixed with graphitizable coke, which causes insufficient thermal uniformity at the time of activation to be difficult for equitable activation, being unlikely to produce the good quality activated carbon having a large electric capacity per volume (F/cm³) industrially and stably. The carbon fiber of more than 20% by mass decreases density of electrode, and likely lowers an electric capacity per volume (F/cm³).

The vapor grown carbon fiber having good thermal and electric conductivity enhances heat radiation, and reinforces function as buffer for dilatation of electrode by mixing the activated carbon particle therewith, which effectively works to prevent from increasing dilatation of electrode at the time of applying voltage.

The carbon black used in the activated carbon electrode layer may be carbon material known as electric conductor for an electrode of an electrochemical device. There are mentioned acetylene black, channel black, furnace black and so on. The amount of the carbon black is usually 0.1 to 20 parts by mass, preferably 0.5 to 10 parts by mass, based on 100 parts by mass of the electrode layer.

The activated carbon electrode layer may be usually produced by rolling a compound comprising the activated carbon, an electric conductive assistant and binder; by coating a paste or a slurry comprising the activated carbon, the electric conductive assistant, binder and optionally solvent, onto a collector; and by burning the mixture comprising the activated carbon and un-carbonized resins.

For example, to the activated carbon powder having average particle size of 1 to 50 μm are added the carbon black as electric conductive assistant, and the binder such as polytetrafluoroethylene (PTFE), polyvinylidene-fluoride, rubber comprising acrylate monomer unit and rubber comprising butadiene monomer unit, to be dry-mixed by blender. To the powder mixture is poured an organic solvent having a boiling point of 200° C. or less, and the powder mixture is swelled. The swelled mixture is formed into sheet having thickness of approximately 0.1 to 0.5 mm. The sheet is dried under reduced pressure at approximately 100 to 200° C. to obtain the electrode layer.

The organic solvent is not limited as long as the organic solvent has a boiling point of 200° C. or less, such as hydrocarbons as toluene, xylene and benzene; ketones as acetone, methylethylketone and butylmethylketone; alcohols as methanol, ethanol and butanol; and esters as ethylacetate and butylacetate.

The preferable organic solvent is toluene, acetone, ethanol or the like. Use of an organic solvent having a boiling point of more than 200° C. is not preferable, because of remaining the organic solvent in a sheet in the drying at 100 to 200° C. after forming the sheet.

The sheet is stamped, and a metallic plate as a collector is laminated onto the stamped sheet to obtain an electrode. Two electrodes are piled in the state that a separator is interposed between the electrodes and the metallic plate is outside, which are steeped in electrolytic solution to be able to obtain an electric double layer capacitor.

The electrolytic solution used in the electric double layer capacitor of the invention comprises non-aqueous solvent and an electrolyte.

Known electrolytes may be used for the electrolyte. For instance, at least one salt selected from the group consisting of quarternary ammonium salts or quarternary phosphonium salts comprising a quarternary onium cation represented by R¹R²R³R⁴N⁺ or R¹R²R³R⁴P⁺ (R¹, R², R³ and R⁴ are respectively alkyl group having 1 to 10 of carbon atoms, or allyl group) and anion such as BF₄⁻, PF₆⁻ and ClO₄⁻; lithium hexafluoro-phosphate (LiPF₆), lithium hexa-fluoro-borate (LiBF₆), lithium hexafluoroarsenate (LiAsF₆) and lithium trifluoromethane sulfonate (CF₃SO₃Li) is preferably employed.

As the specific example of the electrolyte, at least one salt such as (C₂H₅)₄PBF₄, (C₃H₇)₄PBF₄, (CH₃)(C₂H₅)₃NBF₄, (C₂H₅)₄NBF₄, (C₂H₅)₄PPF₆, (C₂H₅)₄PCF₃SO₄, (C₂H₅)₄NPF₆, lithium perchlorate (LiClO₄), lithium hexafluoro-phosphate (LiPF₆), lithium hexa-fluoro-borate (LiBF₄), lithium hexa-fluoro arsenate (LiAsF₆), tri-fluoro methane lithium sulfonate (LiCF₃SO₃), bis-tri-fluoro methyl sulfonil imide lithium (LiN(CF₃SO₂)₂), thiocyanate, and aluminum fluoride may be used. In these, using of ammonium salt is preferable for cyclic property and shelf life.

As non-aqueous solvent are used cyclic esters, acyclic esters, cyclic ethers, acyclic ethers or the like. Specifically, non-aqueous solvent such as propylene carbonate (PC), ethylene carbonate (EC), butylene carbonate (BC), vinylene carbonate, di-methyl carbonate (DMC), di-ethyl carbonate (DEC), γ-butyrolactone (γBL), 2-methyl-γ-butyrolactone, acetyl-γ-butyrolactone, γ-valerolactone, 1,2-dimethoxyethane (DME), 1,2-diethoxyethane, diethyl ether, ethylene glycol di-alkyl ether, di-ethylene glycol di-alkyl ether, tri-ethylene glycol di-alkyl ether, tetra-ethylene glycol di-alkyl ether, di-propyl carbonate, methyl ethyl carbonate, methyl butyl carbonate, methyl propyl carbonate, ethyl butyl carbonate, ethyl propyl carbonate, butyl propyl carbonate, alkyl propionate, di-alkyl malonate, alkyl acetate, tetrahydrofuran (THF), alkyl tetra-hydro furan, di-alkylalkyltetrahydrofuran, alkoxy tetrahydrofuran, di-alkoxy tetrahydrofuran, 1,3-di-oxolane, alkyl-1,3-di-oxolane, 1,4-di-oxolane, 2-methyl tetrahydrofuran, di-methyl sulfoxide, 1,3-dioxolane, formamide, di-methyl formamide, dioxolane, acetonitrile, nitro methane, methyl formate, methyl acetate, methyl propionate, ethyl propionate, tri-alkyl phosphate, maleic anhydride, sulfolane, 3-methyl sulfolane and derivatives or mixture thereof are preferably used. Particularly ethylene carbonate, propylene carbonate, dimethyl carbonate, diethyl carbonate, methylethyl carbonate, acetonitrile, sulfolane, and methylsulfolane are preferably employed.

When the electric double layer capacitor is used for reflow soldering, at least one solvent selected from the group consisting of propylene carbonate (PC), ethylene carbonate (EC), and γ-butyrolactone (γBL) is favorable, since non-aqueous solvent having a boiling point of 200° C. or more at normal pressure is stable for an electrolytic solution.

As impurities contaminated in the non-aqueous solvent are mentioned water, organic peroxides such as glycols, alcohols, and carboxylic acids. The impurities seems to make an insulating coat on the electrode to enlarge interfacial resistance of the electrode, which likely causes to shorten a cyclic life or to decrease a capacity. Also self discharge is apt to be increased while the capacitor is stored in high temperature (60° C. or more). Therefore the impurities in the electrolytic solution comprising non-aqueous solvent are preferably cut down as much as possible. Specifically water is preferably 50 ppm or less in content, organic peroxide is preferably 1000 ppm or less in content.

The separator interposed between the electrodes is not particularly limited as long as it has large ion permeability, set mechanical strength, and stable insulation between anode and cathode. For instance, micro-porous polyethylene film, micro-porous polypropylene film, polyethylene non-woven fabric, polypropylene non-woven fabric, non-woven fabric mixed with glass fiber, and the like are mentioned. The separator having thickness of 0.02 to 0.1 mm made from non-woven fabric, cellulose paper, glass fiber, fluorine resin or polypropylene is preferably employed.

When the electric double layer capacitor is used for reflow soldering, though glass fiber can be used most stably, resin having a thermo-distortion point of 230° C. or more such as polyphenylene sulfide, polyethyleneterephtalate, polyamide, polyimide may be employed. Pore size in the separator is not particularly limited, usually 0.01 to 10 μm. Thickness of the separator is not particularly limited, usually 20 to 100 μm.

The conductive adhesive layer is disposed between a top vessel or a bottom vessel which are collector, and the electrode layer to adhere the electrode layer with the top vessel or the bottom vessel physically and electrically. The conductive adhesive layer at least comprises a conductive particle and a binder adherable with the conductive particle as ingredient. On the collector, application for base layer comprising conductive particle, binder and solvent can be applied to make the conductive adhesive layer.

The conductive adhesive layer preferably comprises carbon black as the conductive particle, and synthetic rubber or acrylic rubber as the binder.

The conductive particle is not particularly limited as long as it is particle being able to transfer charge between the collector (a top vessel or a bottom vessel) and the electrode layer. For instance, particle comprising carbon material having electronic conductivity is mentioned. As the carbon material, carbon black and graphite are mentioned in view of the electronic conductivity. The carbon material particle is preferably 0.335 to 0.338 nm in a lattice plane distance (d₀₀₂), and preferably 50 to 80 nm in a crystal pile thickness (Lc₀₀₂), as measured by X-ray diffraction in view of the electronic conductivity.

Mentioned as the carbon black are acetylene black, ketjen black, channel black, furnace black, thermal black and so on. In these, acetylene black is preferable. The carbon black is preferably 25 to 50 nm in average particle size, and is preferably not less than 50 m²/g, more preferably 50 to 140 m²/g in BET specific surface area. Using of the carbon black can give good electronic conductivity to the conductive adhesive layer to decrease an internal resistance.

Mentioned as the graphite are natural graphite, artificial graphite, expanded graphite and the like. In these, artificial graphite is preferable. The graphite is preferably 4 to 6 μm in average particle size, and preferably not less than 10 m²/g, more preferably 15 to 30 m²/g in BET specific surface area. Using of the graphite can give good electronic conductivity to the base layer to decrease an internal resistance.

The carbon material may be used alone or in combination with at least two selected from the carbon black and graphite.

The binder comprised in the conductive adhesive layer is not particularly limited as long as it is adherable with the conductive particle. For instance, polytetrafluoroethylene (PTFE), polyvinylidene fluoride (PVDF), polyethylene (PE), polypropylene (PP), fluororubber and the like are mentioned. In these, fluororubber is preferable.

As fluororubber are mentioned copolymer of vinylidenfluoride-hexafluoropropylene (VDF-HFP), copolymer of vinylidenfluoride-hexafluoropropylene-tetrafluoroethylene (VDF-HFP-TFE), copolymer of vinylidenefluoride-pentafluoropropylene (VDF-PFP), copolymer of vinylidenefluoride-pentafluoropropylene-tetrafluoroethylene (VDF-PFP-TFE), copolymer of vinylidenfluoride-perfluoromethylvinylether-tetrafluoroethylene (VDF-PFMVE-TFE), copolymer of vinylidenefluoride-chlorotrifluoroethylene (VDF-CTFE), copolymer of ethylene-tetrafluoroethylene, copolymer of propylene-tetrafluoroethylene and the like. In these, fluororubber comprising copolymer of two monomer selected from the group consisting of VDF, HFP and TFE is preferable, copolymer of VDF-HFP-TFE is particularly preferable in view of adhesive of a collector and an electrode layer, and chemical resistance.

The binder may be used alone or in combination with at least two selected from the above. The compounded amount of the binder, depends on a specific surface area of the conductive particle or the desired strength of the electrode, is preferably 30 to 80% by mass, more preferably 50 to 70% by mass to mass of the conductive adhesive layer (conductive particle+binder) at dry measure. Binder is the more adhesive to the conductive particle, adhesion between the collector and the electrode layer is the better even though the compounded amount is little.

The solvent used in application for the conductive adhesive layer is not particularly limited as long as it can dissolve the binder. Organic solvent can be usually used. As the organic solvent are mentioned saturated hydrocarbons such as hexane, aromatic hydrocarbons such as toluene and xylene, alcohols such as methanol, ethanol, propanol and butanol, ketones such as acetone, methylethylketone (MEK), methylisobuthylketone (MIBK) and diisobuthylketone, esters such as ethyl acetate and butyl acetate, ethers such as tetrahydrofuran, dioxane and diethyl ether, amides such as N,N-dimethylformamide, N-methylpyrrolidone and N,N-dimethylacetoamide, halogated hydrocarbons such as ethylene chloride and chlorobenzene. In these, ketones or amides is preferable for dissolving a fluororubber. The solvent can be used alone or in combination with at least two.

The compounded amount of the solvent in the application for the conductive adhesive layer may be about 600 to 2000 parts by mass based on 100 parts by mass of the conductive particle and the binder all in. The amount of the solvent may be determined by account of application property and so on.

In preparing the application for the conductive adhesive layer, the conductive particle, the binder and the solvent are compounded and kneaded to obtain a slurry. The compounding or kneading can be carried out by using roll mill, planetary mixer, open kneader, continuous kneader, press kneader and so on.

The collector (a top vessel or a bottom vessel) is not particularly limited as long as it is a good conductor which can transfer charge to electrode layer through conductive adhesive layer, and the known collector used in an electrode for a capacitor may be employed. For instance, conductive metal such as aluminum, stainless steel is mentioned as collector. The conductive metal includes etched metal, calendered metal and the like. As preferable collector is mentioned collector made from stainless steel.

The electric double layer capacitor may be any of coin type capacitor which a pair of electrode sheets in the state that a separator is interposed between the electrode sheets is put in a metallic case with electrolyte, reel type capacitor which a pair of positive and negative electrodes in the state that a separator is interposed between the electrodes is rolled up, laminate type capacitor which a lot of electrode sheets in the state that a separator is respectively interposed between the electrode sheets are piled, and the like. The electric double layer capacitor in the invention is preferably a coin type capacitor comprising a pair of electrode which the activated carbon electrode layer is adhered to a top vessel or a bottom vessel being collector through conductive adhesive layer.

The capacitor in the invention is preferably assembled in atmosphere of dehumidified air or inert gas. The sections are preferably dried before assembling. As means for drying or dehydration of pellets, sheets or the other sections, conventional means may be used. Specifically, hot wind, vacuum, infrared rays, far infrared rays, electron rays and low humidity wind are preferably used alone or in combination. Temperature is preferably 80 to 350° C., particularly preferably 100 to 250° C. Water content is preferably 2000 ppm or less in cell as a whole, is preferably 50 ppm or less in polarizable electrode and electrolyte respectively in view of improving property of charging and discharging cycle.

The electric double layer capacitor in the invention can be applied to power supply system. The power supply system is applied to a power supply system for car such as automobile and railroad; a power supply system for ship; a power supply system for aircraft; a power supply system for mobile electronic equipment such as cellular phone, mobile information terminal, and mobile electronic calculator; a power supply system for office work; a power supply system for a power generation system such as solar battery power generation system, and wind power generation system; and the like.

Besides the electric double layer capacitor in the invention may be applied to a communication apparatus, and an electronic tag such as IC tag. The electronic tag comprises a transmitter, a radio receiver, a memory and a power source, when the radio receiver receives a set radio wave, the transmitter sends a set signal in the memory. The electric double layer capacitor can be employed as the power source for the electronic tag.

The following examples and comparative examples are shown to explain the invention in the concrete. The invention is not limited by these examples.

### EXAMPLE 1

### Producing of Coin Type Cell (6.8 mmΦ×1.4 mmt)

To 81 parts by mass of activated carbon prepared by alkali-activation having average particle size of 4 μm, BET specific surface area of 1890 m²/g, and the highest peak A within the range of 1 nm to 1.5 nm, in which the peak A is 0.022 cm³/g and is 24% to a total pore volume in a pore size distribution, 10 parts by mass of PTFE (polytetrafluoroethylene) and 9 parts by mass of carbon black were added and kneaded, the kneadate was press-molded at 1 ton/cm² into calendered sheet having thickness of 420 μm. Electrode density of the sheet was 0.62 g/cm³. The sheet was stamped with a punch into disk having diameter of 6.7 mmΦ, and was dried at 200° C. around the clock to obtain a polarizable electrode (activated carbon electrode layer). In a glove compartment in which high purity argon was cycled, the polarizable electrodes (electrode sheets) were adhered with conductive adhesive (rubber based binder: Bunnylite U.C.C) onto a top vessel and a bottom vessel respectively made from stainless steel by drying at 100° C. for 20 minutes. Organic electrolytic solution was infused into the electrode sheet in the top vessel and the bottom vessel before the electrolytic solution was impregnated by being put for 1 minute under decompression of 0.1 MPa and then being put for 1 hour under normal pressure. For the electrolytic solution was used an electrolytic solution produced by TOMIYAMA PURE CHEMICAL INDUSTRIES. Inc. comprising PC (propylene carbonate) as solvent and 1 l/mol of (CH₃)(C₂H₅)₃NBF₄, (C₂H₅)₄NBF₄ as electrolyte. A gasket made from PPS was set in the bottom vessel, separator made from non-woven fabric was set on the electrode in the bottom vessel, the top vessel was set on them, and then the top vessel and the bottom vessel were sealed by being caulked with the gasket.

Charge and discharge operation between 0 V and 2.7 V at 5 mA was carried out by charge and discharge measuring system HJ-101SM6 produced by HOKUTO DENKO Co. An electrostatic capacity per mass (F/g) and an electrostatic capacity per volume (F/cm³) of activated carbon of both electrodes in an electric double layer capacitor were determined from discharge property curve in the 2nd constant current discharge operation.

Two hundred charge and discharge cycle operations were carried out. A retention rate of the electric capacity was determined to evaluate the permanence. The retention rate is measured from quotient of an electric capacity after 200th charge and discharge cycle operation by an electric capacity after 2nd charge and discharge cycle operation.

### EXAMPLE 2

### Production of Coin Type Cell (20 mmΦ×25 mmt)

To 81 parts by mass of activated carbon prepared by alkali-activation having average particle size of 4 μm, BET specific surface area of 2020 m²/g, and the highest peak A within the range of 1 nm to 1.5 nm, in which the peak A is 0.033 cm³/g and is 31% to a total pore volume in a pore size distribution, 10 parts by mass of PTFE (polytetrafluoroethylene) and 9 parts by mass of carbon black were added and kneaded, the kneadate was press-molded at 1 ton/cm² into calendered sheet having thickness of 540 μm. Electrode density of the sheet was 0.61 g/cm³. The sheet was stamped with a punch into disk having diameter of 19.5 mmΦ, and was dried at 200° C. around the clock to obtain a polarizable electrode. In a glove compartment in which high purity argon was cycled, the polarizable electrodes (electrode sheets) were adhered with conductive adhesive (rubber based binder: Bunnylite U.C.C) onto a top vessel and a bottom vessel respectively made from stainless steel by drying at 100° C. for 20 minutes. Organic electrolytic solution was infused into the electrode sheet in the top vessel and the bottom vessel before the electrolytic solution was impregnated by being put for 1 minute under decompression of 0.1 MPa and then being put for 1 hour under normal pressure. For the electrolytic solution was used an electrolytic solution produced by TOMIYAMA PURE CHEMICAL INDUSTRIES. Inc. comprising EC/DEC (ethylene carbonate/diethylene carbonate) as solvent and 1 l/mol of LiPF₆ as electrolyte. A gasket made from PPS was set in the bottom vessel, separator made from non-woven fabric was set on the electrode in the bottom vessel, the top vessel was set on them, and then the top vessel and the bottom vessel were sealed by being caulked with the gasket.

Charge and discharge operation between 0 V and 3 V at 5 mA was carried out by charge and discharge measuring system HJ-101SM6 produced by HOKUTO DENKO Co. An electrostatic capacity per mass (F/g) and an electrostatic capacity per volume (F/cm³) of activated carbon of both electrodes in an electric double layer capacitor were determined from discharge property curve in the 2nd constant current discharge operation.

Two hundred charge and discharge cycle operations were carried out. A retention rate of the electric capacity was determined to evaluate the permanence. The retention rate is measured from quotient of an electric capacity after 200th charge and discharge cycle operation by an electric capacity after 2nd charge and discharge cycle operation.

### EXAMPLE 3

### Activated Carbon+VGCF

To 81 parts by mass of activated carbon prepared by alkali-activation having average particle size of 4 μm, BET specific surface area of 1440 m²/g, and the highest peak A within the range of 1 nm to 1.5 nm, in which the peak A is 0.015 cm³/g and is 8% to a total pore volume in a pore size distribution, 10 parts by mass of PTFE (polytetrafluoroethylene), 6 parts by mass of carbon black and 3 parts by mass of vapor grown carbon fiber (VGCF: produced by SHOWA DENKO K.K.) were added and kneaded, the kneadate was press-molded at 1 ton/cm² into calendered sheet having thickness of 410 μm. Electrode density of the sheet was 0.65 g/cm³. The sheet was stamped with a punch into disk having diameter of 6.7 mmΦ, and was dried at 200° C. around the clock to obtain a polarizable electrode. In a glove compartment in which high purity argon was cycled, the polarizable electrodes were adhered with conductive adhesive (rubber based binder: Bunnylite U.C.C) onto a top vessel and a bottom vessel respectively made from stainless steel by drying at 100° C. for 20 minutes. Organic electrolytic solution was infused into the electrode sheet in the top vessel and the bottom vessel before the electrolytic solution was impregnated by being put for 1 minute under decompression of 0.1 MPa and then being put for 1 hour under normal pressure. For the electrolytic solution was used an electrolytic solution produced by TOMIYAMA PURE CHEMICAL INDUSTRIES. Inc. comprising PC (propylene carbonate) as solvent and 1 l/mol of (CH₃)(C₂H₅)₃NBF₄, (C₂H₅)₄NBF₄ as electrolyte. A gasket made from PPS was set in the bottom vessel, separator made from non-woven fabric was set on the electrode in the bottom vessel, the top vessel was set on them, and then the top vessel and the bottom vessel were sealed by being caulked with the gasket.

Charge and discharge operation between 0 V and 2.7 V at 5 mA was carried out by charge and discharge measuring system HJ-101SM6 produced by HOKUTO DENKO Co. An electrostatic capacity per mass (F/g) and an electrostatic capacity per volume (F/cm³) of activated carbon of both electrodes in an electric double layer capacitor were determined from discharge property curve in the 2nd constant current discharge operation.

Two hundred charge and discharge cycle operations were carried out. A retention rate of the electric capacity was determined to evaluate the permanence. The retention rate is measured from quotient of an electric capacity after 200th charge and discharge cycle operation by an electric capacity after 2nd charge and discharge cycle operation.

### EXAMPLE 4

### Production of Coin Type Cell (3.8 mmΦ×1.1 mmt)

To 85 parts by mass of activated carbon prepared by alkali-activation having average particle size of 7 μm, BET specific surface area of 1790 m²/g, 7 parts by mass of PTFE (polytetrafluoroethylene) and 8 parts by mass of carbon black were added and kneaded, the kneadate was press-molded at 1.5 ton/cm² into calendered sheet having thickness of 330 μm. Electrode density of the sheet was 0.69 g/cm³. The sheet was stamped with a punch into disk having diameter of 2.1 mmΦ, and was dried at 200° C. around the clock to obtain a polarizable electrode. In a glove compartment in which high purity argon was cycled, the polarizable electrodes were adhered with conductive adhesive (rubber based binder: Bunnylite U.C.C) onto a top vessel and a bottom vessel respectively made from stainless steel by drying at 100° C. for 20 minutes. Organic electrolytic solution was infused into the electrode sheet in the top vessel and the bottom vessel before the electrolytic solution was impregnated by being put for 1 minute under decompression of 0.1 MPa and then being put for 1 hour under normal pressure. For the electrolytic solution was used an electrolytic solution produced by TOMIYAMA PURE CHEMICAL INDUSTRIES. Inc. comprising PC (propylene carbonate) as solvent and 1 l/mol of (CH₃)(C₂H₅)₃NBF₄, (C₂H₅)₄NBF₄ as electrolyte. A gasket made from PEEK was set in the bottom vessel, separator made from glass fiber was set on the electrode in the bottom vessel, the top vessel was set on them, and then the top vessel and the bottom vessel were sealed by being caulked with the gasket.

Charge and discharge operation between 0 V and 2.6 V at 10 μA in constant current charge and 5 μA in constant current discharge was carried out by charge and discharge measuring system HJ-101SM6 produced by HOKUTO DENKO Co. An electrostatic capacity per mass (F/g) and an electrostatic capacity per volume (F/cm³) of activated carbon of both electrodes in an electric double layer capacitor were determined from discharge property curve in the 2nd constant current discharge operation (5 μA).

Two hundred charge and discharge cycle operations were carried out. A retention rate of the electric capacity was determined to evaluate the permanence. The retention rate is measured from quotient of an electric capacity after 200th charge and discharge cycle operation by an electric capacity after 2nd charge and discharge cycle operation.

### [TAB.1]

TABLE 1

| | Ex. 1 | Ex. 2 | Ex. 3 | |
|---|---|---|---|---|
| | 6.8 mmΦ | 20 mmΦ | 6.8 mmΦ | Ex. 4 |
| | coin | coin | coin | 3.8 mmΦ coin |
| Acitvated | Pitch based | Pitch based | Pitch based | Pitch based |
| Carbon | alkali | alkali | alkali | alkali |
| | activated | activated | activated | activated |
| | carbon | carbon | carbon | carbon |
| | one layer | one layer | one layer | one layer |
| Thickness | 420 μm | 540 μm | 410 μm | 330 μm |
| of electrode | | | | |
| layer | | | | |
| impregnation | 278% | 316% | 291% | 270% |
| pickup of | | | | |
| electrolytic | | | | |
| solution | | | | |
| capacity | 4.2 | 9.5 | 3.8 | 3.5 |
| (F/cm³) | | | | |
| impedance | 8.9 | 10.1 | 13.0 | 40.0 |
| (Ω) | | | | |
| 200th | 83.40% | 93.90% | 81.60% | 96.40% |
| permanence | | | | |

### EXAMPLE 5

### Production of Coin Type Cell (3.8 mmΦ×1.1 mmt)

To 85 parts by mass of activated carbon prepared by alkali-activation having average particle size of 7 μm, BET specific surface area of 1790 m²/g, 7 parts by mass of PTFE (polytetrafluoroethylene) and 8 parts by mass of carbon black were added and kneaded, the kneadate was press-molded at 2.5 ton/cm² into calendered sheet having thickness of 330 μm. Electrode density of the sheet was 0.77 g/cm³. The sheet was stamped with a punch into disk having diameter of 2.1 mmΦ, and was dried at 200° C. around the clock to obtain a polarizable electrode.

In a glove compartment in which high purity argon was cycled, the polarizable electrodes were adhered with conductive adhesive (rubber based binder: Bunnylite U.C.C) onto a top vessel and a bottom vessel respectively made from stainless steel by drying at 100° C. for 20 minutes. Organic electrolytic solution was infused into the electrode sheet in the top vessel and the bottom vessel before the electrolytic solution was impregnated by being put for 1 minute under decompression of 0.1 MPa and then being put for 1 hour under normal pressure. For the electrolytic solution was used an electrolytic solution produced by TOMIYAMA PURE CHEMICAL INDUSTRIES. Inc. comprising PC (propylene carbonate) as solvent and 1 l/mol of (CH₃)(C₂H₅)₃NBF₄, (C₂H₅)₄NBF₄ as electrolyte. A gasket made from PEEK was set in the bottom vessel, separator made from glass fiber was set on the electrode in the bottom vessel, the top vessel was set on them, and then the top vessel and the bottom vessel were sealed by being caulked with the gasket.

Charge and discharge operation between 0 V and 2.6 V at 10 μA in constant current charge and 5 μA in constant current discharge was carried out by charge and discharge measuring system HJ-101SM6 produced by HOKUTO DENKO Co. An electrostatic capacity per mass (F/g) and an electrostatic capacity per volume (F/cm³) of activated carbon of both electrodes in an electric double layer capacitor were determined from discharge property curve in the 2nd constant current discharge operation (5 μA).

Two hundred charge and discharge cycle operations were carried out. A retention rate of the electric capacity was determined to evaluate the permanence. The retention rate is measured from quotient of an electric capacity after 200th charge and discharge cycle operation by an electric capacity after 2nd charge and discharge cycle operation.

### COMPARATIVE EXAMPLE 1

### Piling of Two Thin Electrode Sheets

To 81 parts by mass of activated carbon prepared by alkali-activation having average particle size of 4 μm, BET specific surface area of 1890 m²/g, and the highest peak A within the range of 1 nm to 1.5 nm, in which the peak A is 0.022 cm³/g and is 24% to a total pore volume in a pore size distribution, 10 parts by mass of PTFE (polytetrafluoroethylene) and 9 parts by mass of carbon black were added and kneaded, the kneadate was press-molded at 1 ton/cm² into calendered sheet having thickness of 280 μm. Electrode density of the sheet was 0.62 g/cm³. The sheet was stamped with a punch into disk having diameter of 6.7 mmΦ, and was dried at 200° C. around the clock to obtain a polarizable electrode (thin electrode sheet). Coin type cell (6.8 mmΦ×1.4 mm) was produced by the same manner as EXAMPLE 1 except that the electrode made by piling two thin electrode sheets was used. And charge and discharge property and permanence were determined.

### COMPARATIVE EXAMPLE 2

Charge and discharge property and permanence of commercial coin type capacitor (6.8 mmΦ×1.4 mm, trade name PAS614L, produced by SHOEI Electronics Co., Ltd.) were determined by the same manner as the EXAMPLE 1.

### COMPARATIVE EXAMPLE 3

### Coin Type Cell (20 mmΦ×25 mm) Made by Using Activated Carbon Having No Peak A

To 81 parts by mass of activated carbon MSP-20 (produced by KANSAI COKE AND CHEMICALS Co., Ltd.) having average particle size of 3 μm, BET specific surface area of 2200 m²/g, and the highest peak A within the range of 1 nm to 1.5 nm, in which the peak A is 0.08 cm³/g and is 0.9% to a total pore volume in a pore size distribution, 10 parts by mass of PTFE (polytetrafluoroethylene) and 9 parts by mass of carbon black were added and kneaded, the kneadate was press-molded at 1 ton/cm² into calendered sheet having thickness of 550 μm. Electrode density of the sheet was 0.59 g/cm³. The sheet was stamped with a punch into disk having diameter of 19.5 mmΦ, and was dried at 200° C. around the clock to obtain a polarizable electrode. In a glove compartment in which high purity argon was cycled, the polarizable electrodes were adhered with conductive adhesive (rubber based binder: Bunnylite U.C.C.) onto a top vessel and a bottom vessel respectively made from stainless steel by drying at 100° C. for 20 minutes. Organic electrolytic solution was infused into the electrode sheet in the top vessel and the bottom vessel before the electrolytic solution was impregnated by being put for 1 minute under decompression of 0.1 MPa and then being put for 1 hour under normal pressure. For the electrolytic solution was used an electrolytic solution produced by TOMIYAMA PURE CHEMICAL INDUSTRIES. Inc. comprising PC (propylene carbonate) as solvent and 1 l/mol of (CH₃)(C₂H₅)₃NBF₄, (C₂H₅)₄NBF₄ as electrolyte. A gasket made from PPS was set in the bottom vessel, separator made from non-woven fabric was set on the electrode in the bottom vessel, the top vessel was set on them, and then the top vessel and the bottom vessel were sealed by being caulked with the gasket.

Charge and discharge operation between 0 V and 3 V at 5 mA was carried out by charge and discharge measuring system HJ-101SM6 produced by HOKUTO DENKO Co. An electrostatic capacity per mass (F/g) and an electrostatic capacity per volume (F/cm³) of activated carbon of both electrodes in an electric double layer capacitor were determined from discharge property curve in the 2nd constant current discharge operation.

Two hundred charge and discharge cycle operations were carried out. A retention rate of the electric capacity was determined to evaluate the permanence. The retention rate is measured from quotient of an electric capacity after 200th charge and discharge cycle operation by an electric capacity after 2nd charge and discharge cycle operation.

### [TAB.2]

TABLE 2

| | Ex. 5 | Comp. Ex. 1 | Comp. Ex. 2 | |
|---|---|---|---|---|
| | 3.8 mmΦ | 6.8 mmΦ | 6.8 mmΦ | Comp. Ex. 3 |
| | coin | coin | coin | 20 mmΦ coin |
| Acitvated | Pitch based | Pitch based | PolyAcenic | Phenol based |
| Carbon | alkali | alkali | active | alkali |
| | activated | activated | carbon | activated |
| | carbon | carbon | | carbon |
| | one layer | two layers | | one layer |
| Thickness | 330 μm | 280 μm × | 300 μm | 550 μm |
| of electrode | | 2 sheets | | |
| layer | | | | |
| impregnation | 255% | 249% | N.D. | 236% |
| pickup of | | | | |
| electrolytic | | | | |
| solution | | | | |
| capacity | 3.6 | 2.6 | 1.7 | 3.3 |
| (F/cm³) | | | | |
| impedance | 73.5 | 25.8 | 118 | 178 |
| (Ω) | | | | |
| 200th | 96.80% | 69.80% | 53.50% | 73.30% |
| permanence | | | | |

1. An electric double layer capacitor comprising:
activated carbon electrode layers comprising an activated carbon,
conductive adhesive layers,
a separator and
electrolytic solution comprising non-aqueous solvent and electrolyte between a top vessel and a bottom vessel;
in which the top vessel and the bottom vessel are sealed by being caulked with a gasket;
in which the activated carbon electrode layers are 0.3 mm or more in a thickness per a layer, not less than 0.55 g/cm³ and not more than 0.8 g/cm³ in an electrode density, and 250% or more in impregnation pickup of electrolytic solution.

2. The electric double layer capacitor according to the claim 1, in which the activated carbon electrode layers are 0.4 mm or more in a thickness per a layer.

3. The electric double layer capacitor according to the claim 1, in which the activated carbon electrode layers are not less than 0.65 g/cm³ and not more than 0.8 g/cm³ in an electrode density.

4. The electric double layer capacitor according to claim 1, in which the activated carbon electrode layer is 20Ω or less in an impedance at 1 kHz in frequency.

5. The electric double layer capacitor according to claim 1, in which the activated carbon electrode layer comprises an activated carbon having a BET specific surface area of 1100 to 2200 m²/g, in which the activated carbon is obtained by activating a graphitizable coke made of coal based pitch or petroleum based pitch as raw material in the presence of alkali metallic compound.

6. The electric double layer capacitor according to claim 1, in which the activated carbon electrode layer comprises an activated carbon which has the highest peak A within the range of 1 nm to 1.5 nm, in which the peak A is from 0.012 cm³/g to 0.050 cm³/g and is from 2% to 32% to a total pore volume, in a pore size distribution.

7. The electric double layer capacitor according to the claim 6, in which the activated carbon further has a peak B within the range of 1.5 to 1.7 nm, a peak C within the range of 1.7 to 2 nm, and a peak D within the range of 2 to 2.5 nm, in a pore size distribution.

8. The electric double layer capacitor according to claim 1, in which the activated carbon electrode layer comprises an activated carbon having average particle size of not less than 2 μm and not more than 15 μm, fluorine containing polymer compound as a binder, and a carbon black and/or a vapor grown carbon fiber as a conductive assistant.

9. The electric double layer capacitor according to claim 1, in which the conductive adhesive layer comprises a carbon black as a conductive particle, and synthetic rubber or acrylic rubber as a binder.

10. The electric double layer capacitor according to claim 1, in which the electrolyte is at least one salt selected from the group consisting of quarternary ammonium salts or quarternary phosphonium salts comprising quarternary onium cation represented by R¹R²R³R⁴N⁺ and R¹R²R³R⁴P⁺ (R¹, R², R³ and R⁴ are respectively alkyl group having 1 to 10 of carbon atom, or allyl group) and anion selected from the group consisting of BF₄⁻, PF₆⁻ and ClO₄⁻; lithium hexafluoro-phosphate (LiPF₆), lithium hexafluoro-borate (LiBF₆), lithium hexafluoro-arsenate (LiAsF₆), and lithium trifluoromethane sulfonate (CF₃SO₃Li).

11. The electric double layer capacitor according to claim 1, in which the non-aqueous solvent is at least one selected from the group consisting of ethylene carbonate, propylene carbonate, di-methyl carbonate, di-ethyl carbonate, methylethyl carbonate, acetonitrile, sulfolane, and methyl sulfolane.

12. The electric double layer capacitor according to claim 1, in which the separator is made from non-woven fabric, cellulosic paper, glass fiber, fluororesin, or polypropylene, and has a thickness of 0.02 to 0.1 mm.

13. A portable apparatus in which the electric double layer capacitor according to claim 1 is employed.
